(19) United States
(12) Patent Application Publication
(10) Pub. No.: US 2006/0075899 A1
(43) Pub. Date: Apr. 13, 2006

(54) Disposable HEPA filtration adapter

(75) Inventor: James B. Evans, New Woodstock, NY (US)

Correspondence Address: BOND, SCHOENECK & KING, PLLC, ONE LINCOLN CENTER, SYRACUSE, NY, 13202-1355, US

(73) Assignee: O'Brien & Gere Engineers, Inc., Syracuse, NY (US)

(21) Appl. No.: 11/243,176

(22) Filed: Oct. 4, 2005

Related U.S. Application Data
(60) Provisional application No. 60/615,731, filed on Oct. 4, 2004.

(51) Int. Cl. B01D 46/00

(52) U.S. Cl. 96/415; 96/416; 55/503

(57) ABSTRACT

An apparatus is disclosed, for filtering, containing and removing mold spores and other undesirable particulates in conjunction with a conventional vacuum cleaner. The apparatus includes a cylindrical housing that contains a HEPA filter. The cylindrical housing is connected to an exhaust tubular connection which connects to a conventional vacuum or other vacuum source. The cylindrical housing is also connected to an intake tubular connection for drawing in a stream of air from which particles will be filtered. The cylindrical housing also includes a valve for selectively sealing the interior of the cylindrical housing from the atmosphere. According to one embodiment, the apparatus also includes a pressure relief valve for controlling the vacuum pressure. According to another embodiment, the apparatus includes a clamp for securing the apparatus to hoses of various sizes.

### CROSS-REFERENCE TO RELATED APPLICATION

The present application claims priority to U.S. Provisional Application Ser. No. 60/615,731, filed Oct. 4, 2004, the entirety of which is hereby incorporated by reference.

### BACKGROUND OF THE INVENTION

The present invention relates generally to filters, and more particularly to HEPA filter modules adapted for use in connection with standard vacuum equipment to assist in the removal of mold spores, similar toxins and other particulates.

Airborne mold spores can destroy humans' health. Many people are unaware that they are breathing mold spores until they are very sick. If one is lucky and has a minor allergic reaction to the mold, the reaction will subside upon leaving the affected area. It is possible that learning disabilities, mental deficiencies, heart problems bleeding lungs and other serious ailments can result from mold exposure.

Approximately 25 million Americans suffer from allergic reactions to molds, and most do not realize that when they are sneezing and sniffling the cause could be molds. Many molds produce airborne toxins that can cause serious breathing difficulties, memory and hearing loss, dizziness, flu-like symptoms, and bleeding in the lungs. Common ailments from mold—including allergies, asthma and bruising—usually can be treated and reduced after people leave their contaminated environment. But other health problems may remain permanently, such as brain damage and weakened immune systems.

Fungus reproduces into spores that come in many different sizes, shapes and colors. The spores will reproduce and germinate into new mold growth which in turn can produce millions of more spores. Molds are most prevalent from spring through late fall, but in warm climates, molds thrive all year and can cause year-round problems.

Molds can be found wherever there is moisture, oxygen, warmth and something to feed on. In the fall they grow on rotting logs and fallen leaves, especially in moist, shady areas. In gardens, they can be found in compost piles and on certain grasses and weeds. Molds grow in homes in moist warm areas like damp basements, closets, and bathrooms. Also molds can grow in places where fresh food is stored, refrigerator drip trays, house plants, humidifiers, garbage pails, mattresses, upholstered furniture, or foam rubber pillows. Molds can grow inside the walls and flooring of homes, wherever there are wet cellulose materials they can feed on, such as wood, ceiling tiles, or plasterboard.

Molds come in at least a thousand different varieties, but only a few are the offenders that invade homes. Alternaria and Cladosporium are the molds most commonly found both indoors and outdoors throughout the United States. Aspergillus, Penicillium, Helminthosporium, Epicoccum, Fusarium, Mucor, Rhizopus, and Aureobasidium are also common. The most dangerous mold strains are stachybotrys. This black fungus releases toxic, microscopic spores that cause the worst symptoms that are usually irreversible.

The key to mold prevention and mold & mildew removal is to eliminate moisture. Basements must be dried out, and humidity levels should be maintained at about 50% relative humidity or lower to prevent mold growth. Dehumidifiers can be very useful. Vapor steam cleaning or vacuuming with High Efficiency Particulate Absolute (HEPA) filter vacuums can reduce mold spore concentrations in damp areas and carpets, but if not done properly mold spores can remain or be spread into the air.

Vacuum systems that incorporate HEPA filters therein are now prevalent. However, the HEPA filters are permanent parts of the vacuum system. When the filter is cleaned, it is necessary to release the filtered matter into the environment, thus partially defeating the purpose for which the filter was used in the first place.

It is therefore a principal object and advantage of the present invention to provide a disposable and portable HEPA filtration adapter that may be used in combination with conventional vacuum cleaners.

It is a further object and advantage of the present invention to provide a HEPA filter adapter device that may be disposed of without releasing any of the filtered matter into the open atmosphere.

Other objects and advantages of the present invention will in part be obvious, and in part appear hereinafter.

### SUMMARY OF THE INVENTION

In accordance with the foregoing objects and advantages, a HEPA filter adapter comprises a cylindrical housing having an intake end and an exhaust end. The intake end comprises a diverging nozzle and includes a tubular extension protruding therefrom. The tubular extension includes a flanged end that is positioned within the intake end and prevents it from becoming disconnected therefrom. The tubular extension is adapted to be interconnected to a flexible cleaning hose. The exhaust end includes a tubular extension protruding therefrom that is adapted to be interconnected to the vacuum source. An adjustable collar may be used to secure the connection between the exhaust tube and a tube leading to the vacuum source. In operation, actuation of the vacuum causes air and particles to be drawn through the HEPA filter, entrapping bacteria, spores, and other toxic matter in the filter medium. The adaptor can be discarded after a use without having to expose the filter, thus eliminating the escape of harmful toxins entrapped within the filter media.

### BRIEF DESCRIPTION OF THE DRAWINGS

The present invention will be more fully understood and appreciated by reading the following Detailed Description in conjunction with the accompanying drawings, in which:

FIG. 1 is a side elevation view of an embodiment of the present invention taken in cross-section;

FIG. 2 is a partial perspective sectional view of the present invention;

FIG. 3 is a cross sectional view of an embodiment of the invention taken along section line 2-2 of FIG. 1; and

FIG. 4 is a partial side elevation view of the outlet end of the adapter, shown with a flexible hose connector thereon.

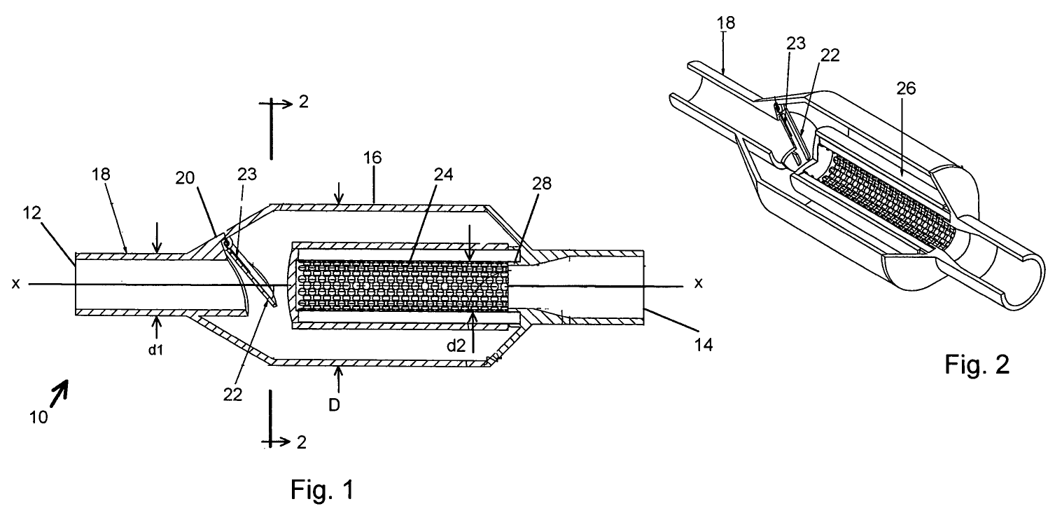

### DETAILED DESCRIPTION

Referring now to the drawings, in which like reference numeral refer to like parts throughout, there is seen in FIG. 1 HEPA filter adapter designated generally by reference numeral 10. HEPA filter adapter 10 comprises an intake end 12, an outlet end 14, and a filter housing 16 integrally extending therebetween. Filter adapter 10 is preferably composed of a translucent or transparent plastic material that permits the user to visually inspect the capacity of the filter housed therein, but may be composed of any suitable material.

Intake end 12 includes a constant cross-sectional inlet 18 and a diverging nozzle portion 20 extending from the cross-sectional diameter d1 of inlet 18 to the larger cross-sectional diameter D of filter housing 16. A spring biased valve 22 is positioned adjacent the open end and is selectively movable between full suction, wherein the valve is positioned co-linearly with the longitudinal axis X-X of adapter 10, and fully closed, wherein the valve is positioned perpendicularly to the longitudinal axis X-X. Inlet end 12 is adapted for operation by itself or for connection to conventional cleaning nozzles (not shown.)

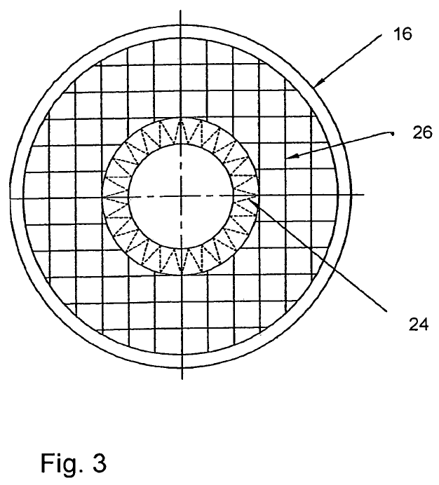

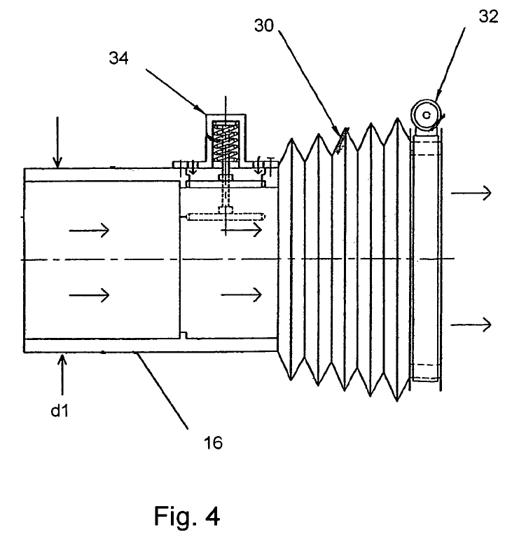

Filter housing 16 is of an essentially continuous cross-sectional diameter D and includes a HEPA filter module 24 securely and concentrically positioned therein. Filter module 24 is of a diameter d2, smaller than diameter D, thereby leaving a concentric amount of space between it and then interior wall of filter housing 16. According to one embodiment, large mesh screen 26 (FIG. 3) is positioned at the interface of filter housing 16 and intake 12, and includes the leading end of HEPA filter 24 centrally positioned therein. Screen 26 filters out larger size particles before they enter filter housing 16 and clog filter 24. The trailing end of filter housing 16 uniformly converges from diameter D to diameter d1. The trailing end of filter 24 is securely positioned within a gasket assembly 28 that forms the interface between filter housing 16 and outlet 14. Gasket assembly 28 securely retains filter 24 in position within housing 16.

Outlet 14 is of constant cross-section d1 and may include a flexible hose 30 for interconnecting adapter 10 to a conventional vacuum cleaner, such as a wet vacuum (not shown.) A finger actuated clamp 32 may be used to tighten the connection between hose 30 and a vacuum source. In addition, a pressure relief valve 34 may be incorporated into outlet 14 to permit the amount of suction to be increased or decreased depending on how much capacity filter 24 has at any given point of time.

What is claimed is:

1. A portable and disposable apparatus for filtering and disposing of undesirable particles, said apparatus comprising:
a cylindrical housing with an intake end and an exhaust end;
a filter fixed within said cylindrical housing;
a diverging nozzle fixed to said intake end, said diverging nozzle comprising a valve and a first tubular extension; and
a second tubular extension fixed to said exhaust end for connection to a vacuum source.

2. The apparatus of claim 1 wherein said first tubular extension extends into the interior of said diverging nozzle.

3. The apparatus of claim 1 wherein said cylindrical housing is translucent.

4. The apparatus of claim 1 wherein said cylindrical housing is transparent.

5. The apparatus of claim 1 wherein said valve is biased to a closed position.

6. The apparatus of claim 5 wherein said valve opens when a vacuum is applied to said cylindrical housing.

7. The apparatus of claim 6 wherein said valve is positioned within said diverging nozzle.

8. The apparatus of claim 1, further comprising an adjustable clamp for securing said second tubular extension to a vacuum hose.

9. The apparatus of claim 1, wherein said second tubular extension further comprises a pressure relief valve.

10. The apparatus of claim 1, wherein said filter is a HEPA filter.

11. A particulate filtration and disposal system comprising:
a disposable cylindrical housing having an intake end and an exhaust end, said disposable cylindrical housing containing a filter;
wherein said exhaust end is fixed to a tubular exhaust extension;
wherein said intake end is fixed to a diverging nozzle and said diverging nozzle is fixed to a tubular intake extension; and
wherein said tubular intake extension includes a valve for selectively sealing the interior of said cylindrical housing from the atmosphere.

12. The particulate filtration and disposal system of claim 11, further comprising:
a vacuum source; and
a hose for connecting said vacuum source to said tubular exhaust extension.

13. The particulate filtration and disposal system of claim 11, wherein said filter is a HEPA filter.
